(19) United States
(12) Patent Application Publication
(10) Pub. No.: US 2020/0354505 A1
(43) Pub. Date: Nov. 12, 2020

(54) POLYURETHANE WITH (5-ALKYL -1,3-DIOXOLEN-2-ONE-4-YL) END GROUPS

(71) Applicant: Bostik SA, Colombes (FR)

(72) Inventors: Guillaume MICHAUD, Venette (FR); Frédéric SIMON, Venette (FR); Stéphane FOUQUAY, Venette (FR)

(21) Appl. No.: 16/764,428

(22) PCT Filed: Nov. 21, 2018
(86) PCT No.: PCT/FR2018/052942

§ 371 Date: May 15, 2020

(30) Foreign Application Priority Data
Nov. 22, 2017 (FR) 1761033

(51) Int. Cl. C08G 18/48; C09J 175/08; C08G 18/76; C08G 18/28; C08G 18/10

(52) U.S. Cl. CPC C08G 18/4829; C09J 175/08; C08G 18/10; C08G 18/4825; C08G 18/2815; C08G 18/7621

(57) ABSTRACT

The present invention relates to a polyurethane (PP2) comprising at least two, preferably two or three, end functions T of formula (I), in which R¹ and R², which are the same or different, are each a hydrogen atom, a preferably C1-C6, linear or branched alkyl group, a preferably C5-C6 cycloalkyl group, a preferably C6-C12 phenyl group, or an alkylphenyl group with a preferably C1-C4, linear or branched alkyl chain; where R¹ and R² can be bound to form together a —(Ch₂)ₙ— grouping, with n=3, 4 or 5; and the uses thereof.

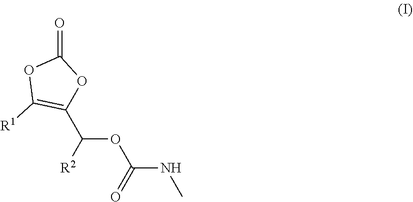

### FIELD OF THE INVENTION

The present invention relates to a polyurethane having (5-alkyl-1,3-dioxolen-2-on-4-yl) end groups, and to its process of preparation.

The present invention also relates to a multicomponent system comprising said polyurethane.

The invention also relates to a process for assembling materials by adhesive bonding, employing said polyurethane.

### TECHNOLOGICAL BACKGROUND

Polyurethane-based adhesive (bonding or mastic) compositions, in particular in the form of multicomponent (generally two-component) systems in which the (two) reactive components necessary for the synthesis of the polyurethane are stored separately and mixed at the final moment before use of the adhesive composition, have been known for a long time.

In order for such a system to be correctly employed, it is preferable for the reactive components to exhibit, on the one hand, a sufficient reactivity for the reaction to take place and to be implemented rapidly and, on the other hand, a viscosity suited to the mixing temperature, in order for the mixing to be easily implemented.

Conventionally, the synthesis of a polyurethane takes place by a polyaddition reaction between a polyol and a polyisocyanate.

However, polyisocyanates are compounds which are very sensitive in the presence of atmospheric moisture and require that appropriate measures be taken in order to prevent them from crosslinking prematurely and thus losing their reactivity during the handling and storage thereof (anhydrous conditions). Furthermore, some of these compounds, such as hexamethylene diisocyanate (HDI), isophorone diisocyanate (IPDI), toluene diisocyanate (TDI) or diphenylmethane diisocyanate (MDI), are known as presenting toxicological risks to man and the environment and the most volatile can even generate toxic emissions.

The use and the storage of large amounts of such polyisocyanates is thus to be avoided as this requires the installation of complex and expensive safety devices suited to their use and their storage. In particular, it is desirable to avoid having recourse to such compounds during the final stage of synthesis of the polyurethane, in order to be able to make available to the public polyurethane-based adhesive compositions in the form of multicomponent systems which are more friendly to man and his environment and more stable in storage.

In addition, when it is desired to formulate compositions in the form of a kit which is transportable, practical and easy and rapid to employ on demand (Do It Yourself), the mixing of the reactants has to be able to be carried out as much as possible on restricted volumes and at low temperature, in particular at room temperature.

WO 2015/140458 describes multi-component and in particular two-component systems obtained by mixing a component A, comprising at least one polyurethane prepolymer functionalized with glycerol carbonate at the chain end, with a component B, comprising at least two primary and/or secondary amine groups. Although these compositions exhibit the advantage of not using polyisocyanate during the mixing of the components A and B, the reaction of the (2-oxo-1,3-dioxolan-4-yl) groups of the component A with the primary and/or secondary amine groups of the component B is slow at low temperature. It is therefore necessary to mix said components at a high temperature, for example at 80° C. Thus, such systems remain to be improved in terms of reactivity.

Consequently, there exists a need to make available polyurethane-based compositions which do not exhibit the disadvantages of the prior art. More particularly, there exists a need for novel polyurethane-based compositions exhibiting a better reactivity at low temperature, while retaining satisfactory adhesive properties.

There also exists a need to formulate polyurethane-based compositions, available in the form of multicomponent and in particular two-component systems, which are easier to use in comparison with the prior art, at mixing and reaction temperatures of less than 60° C., preferably of less than or equal to 35° C. and more preferentially close to room temperature (23° C.).

In particular, there exists a need to find compositions available in the form of multicomponent systems, in particular transportable systems (kits), which are friendly to man and to the environment.

There also exists a need to make available multicomponent systems, the use of which results in adhesive compositions, in particular bonding or mastic compositions, exhibiting mechanical (for example, elongation and/or modulus) performance qualities suited to the use of the adhesive composition.

In addition, there exists a need to develop a process for the preparation of such adhesive compositions which is economical, rapid to carry out and/or friendly to man and to the environment. Desired in particular is a process for the preparation of such compositions which is not very expensive in energy and which does not employ a large amount of solvent, in contrast to the existing preparation processes.

### DESCRIPTION OF THE INVENTION

In the present patent application, unless otherwise indicated:
the amounts expressed in the percentage form correspond to weight/weight percentages;
the number-average molar masses, expressed in grams per mole (g/mol), are determined by calculation by the analysis of the content of end (NCO, OH and functional groups T) groups, expressed in milliequivalents per gram (meq/g), and the functionality (number of functional group NCO, OH or functional group T per mole) of the compound under consideration (polyurethane having NCO end groups (PP1), polyol, compound of formula (III) or polyurethane comprising at least two end functional groups T (PP2) respectively);
the hydroxyl number of an alcohol product represents the number of hydroxyl functional groups per gram of product and is expressed in the form of the equivalent number of milligrams of potassium hydroxide (KOH) used in the assaying of the hydroxyl functional groups per gram of product;
the measurement of viscosity at 23° C. can be carried out using a Brookfield viscometer according to the standard ISO 2555. Typically, the measurement carried out at 23° C. can be performed using a Brookfield RVT viscometer with a spindle suited to the viscosity range and at a rotational speed of 20 revolutions per minute (rev/min);
the measurement of viscosity at 60° C. can be carried out using a Brookfield RVT viscometer coupled with a heating module of Thermosel type of the Brookfield brand, with a spindle suited to the viscosity range and at a rotational speed of 20 revolutions per minute.

### A. Polyurethane

The present invention relates to a polyurethane (PP2) comprising at least two, preferably two or three, end functional groups T of following formula (I):

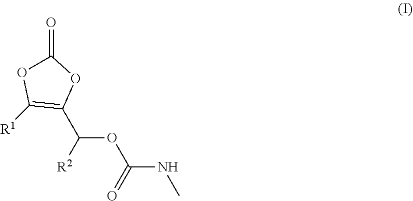

in which R¹ and R², which are identical or different, each represent a hydrogen atom, a linear or branched alkyl group, preferably a C₁-C₆ alkyl group, a cycloalkyl group, preferably a C₅-C₆ cycloalkyl group, a phenyl group, preferably a C₆-C₁₂ phenyl group, or an alkylphenyl group with a linear or branched alkyl chain, preferably a C₁-C₄ alkyl chain; or R¹ and R² can be bonded together to form a —(CH₂)ₙ— group with n=3, 4 or 5.

Preferably, the abovementioned polyurethane (PP2) additionally comprises at least one repeat unit comprising one of the following divalent radicals R³:
a) —(CH₂)₅— divalent radical derived from pentamethylene diisocyanate (PDI),
b) —(CH₂)₆— divalent radical derived from hexamethylene diisocyanate (HDI),
c) the divalent radical derived from isophorone:

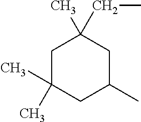

d) the divalent radical derived from TDI;
e) the divalent radical derived from MDI;
f) the divalent radical derived from xylylene diisocyanate (XDI);
g) the divalent radical derived from 1,3-bis(isocyanatomethyl)cyclohexane (m-H6XDI):

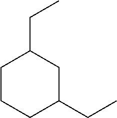

h) the divalent radical derived from 4,4′-methylenedicyclohexyl diisocyanate (H12MDI):

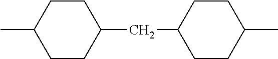

Preferably, the abovementioned polyurethane (PP2) additionally comprises at least one repeat unit comprising one of the following divalent radicals R³:
a) —(CH₂)₅— divalent radical derived from pentamethylene diisocyanate (PDI),
b) —(CH₂)₆— divalent radical derived from hexamethylene diisocyanate (HDI),
c) the divalent radical derived from isophorone:

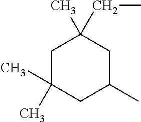

d) the divalent radical derived from 2,4-TDI:

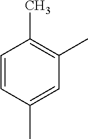

e) the divalent radical derived from 2,4′-MDI:

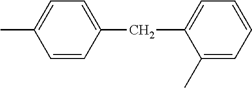

f) the divalent radical derived from meta-xylylene diisocyanate (m-XDI):

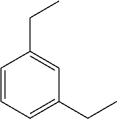

g) the divalent radical derived from 1,3-bis(isocyanatomethyl)cyclohexane (m-H6XDI):

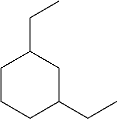

h) the divalent radical derived from 4,4′-methylenedicyclohexyl diisocyanate (H12MDI):

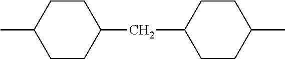

According to one embodiment, the abovementioned polyurethane (PP2) has the following formula (II):

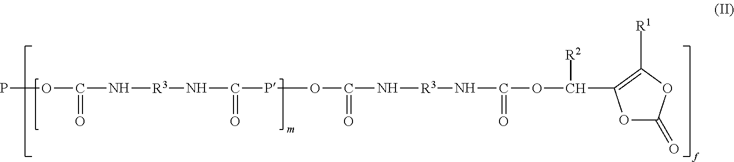

in which:
R¹ and R² are as defined above, R′ preferably being a methyl and R² preferably being a hydrogen atom;
P represents one of the two formulae below:

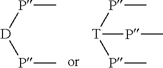

in which D and T represent, independently of each other, a hydrocarbon radical comprising from 2 to 66 carbon atoms which is linear or branched, cyclic, alicyclic or aromatic, saturated or unsaturated, optionally comprising one or more heteroatoms;
P′ and P″ being, independently of each other, a divalent radical resulting from a polyol preferably chosen from polyether polyols, polydiene polyols, polyester polyols and polycarbonate polyols, the polyols preferentially being those described below for stage E1;
R³ being as defined above;
m and f are integers such that the average molecular mass of the polyurethane ranges from 600 to 100 000 g/mol;
f is equal to 2 or 3.

The abovementioned polyurethane (PP2) can have a viscosity, measured at room temperature (23° C.), of less than or equal to 1500 Pa·s, more preferentially of less than or equal to 600 Pa·s and better still of less than or equal to 400 Pa·s.

The polyurethane (PP2) according to the invention can have a viscosity, measured at 60° C., of less than or equal to 50 Pa·s, more preferentially of less than or equal to 40 Pa·s and better still of less than or equal to 30 Pa·s.

Preferably, the abovementioned polyurethane (PP2) has a viscosity, measured at room temperature (23° C.), of less than or equal to 600 Pa·s and a viscosity, measured at 60° C., of less than or equal to 40 Pa·s.

The abovementioned polyurethane (PP2) comprising at least two end functional groups T can be obtained by reaction of a polyurethane having NCO end groups (PP1) and of at least one compound of following formula (III):

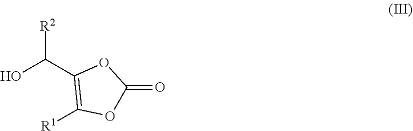

in which R¹ and R², which are identical or different, each represent a hydrogen atom, a linear or branched alkyl group, preferably a C₁-C₆ alkyl group, a cycloalkyl group, preferably a C₅-C₆ cycloalkyl group, a phenyl group, preferably a C₆-C₁₂ phenyl group, or an alkylphenyl group with a linear or branched alkyl chain, preferably a C₁-C₄ alkyl chain; or R¹ and R² can be bonded together to form a —(CH₂)ₙ— group with n=3, 4 or 5.

The compounds of formula (III) can be synthesized as described in EP 0 078 413, for example according to the following scheme:

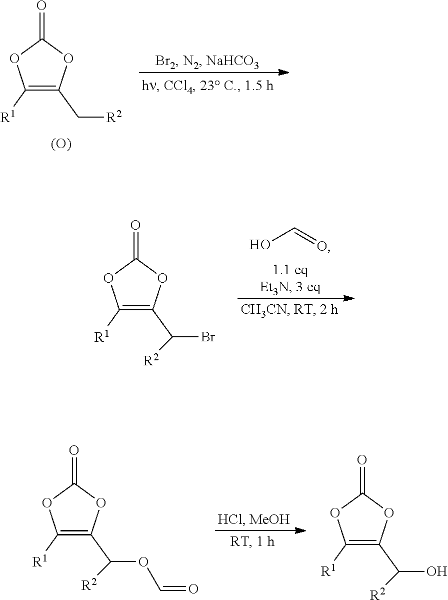

The abovementioned compound (O) can be synthesized by the methods described in Liebigs Annalen der Chemie, Vol. 764, pages 116-124 (1972), Tetrahedron Letters, 1972, pages 1701-1704, or U.S. Pat. No. 3,020,290.

The compounds of formula (III) can also be prepared as described in WO 96/02253.

According to a preferred embodiment, the compounds of formula (II) are those corresponding to the following formula (III-1):

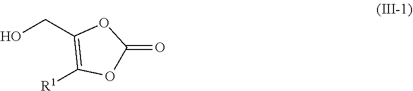

in which R¹ is as defined above. The compounds of formula (III-1) are compounds of formula (III) in which R² is a hydrogen.

According to a preferred embodiment, the compounds of formula (III) have the following formula (III-1a):

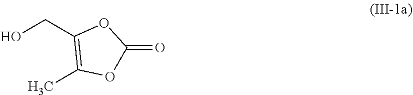

The compound of formula (III-1a) is 4-hydroxymethyl-5-methyl-1,3-dioxolen-2-one. The compound of formula (III-1a) is a compound of formula (III) in which R² is a hydrogen, and R¹ is a methyl.

The compound of formula (III-1a) can be obtained as described in WO 96/02253, namely in particular according to the following scheme:

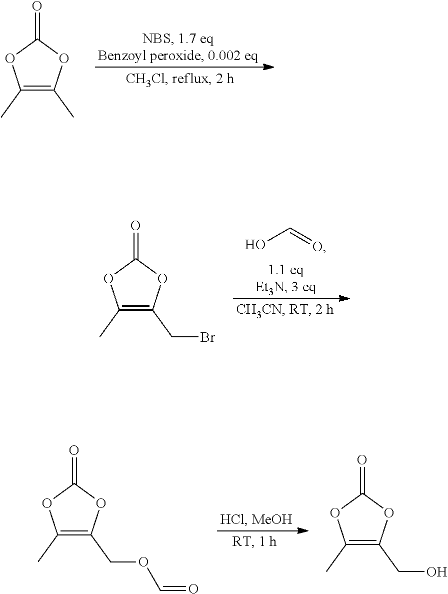

### B. Process

The present invention also relates to a process for the preparation of an abovementioned polyurethane (PP2) comprising at least two, preferably two or three, end functional groups T of formula (I), comprising:
in a first stage (denoted E1), the preparation of a polyurethane having NCO end groups (PP1) by a polyaddition reaction:
   (i) of at least one polyisocyanate preferably chosen from diisocyanates and especially from the following diisocyanates:
a1) pentamethylene diisocyanate (PDI),
a2) hexamethylene diisocyanate (HDI),
a3) isophorone diisocyanate (IPDI),
a4) 2,4-toluene diisocyanate (2,4-TDI),
a5) 2,4′-diphenylmethane diisocyanate (2,4′-MDI),
a6) meta-xylylene diisocyanate (m-XDI),
a7) 1,3-bis(isocyanatomethyl)cyclohexane (m-H6XDI),
a8) 4,4′-methylenedicyclohexyl diisocyanate (H12MDI),
a9) and their mixtures;
   (ii) with at least one polyol preferably chosen from polyether polyols, polyester polyols, polydiene polyols, polycarbonate polyols and their mixtures, in amounts of polyisocyanate(s) and of polyol(s) resulting in an NCO/OH molar ratio, denoted r₁, strictly of greater than 1, preferably ranging from 1.6 to 1.9, preferentially ranging from 1.65 to 1.85; and
in a second stage (denoted E2), the reaction of the product formed on conclusion of the first stage E1 with at least one compound of formula (III) as defined above, in amounts such that the NCO/OH molar ratio, denoted r₂, is less than or equal to 1, preferably of between 0.9 and 1.0, preferably of between 0.95 and 1.0.

Within the context of the invention, and unless otherwise mentioned, r₁ is the NCO/OH molar ratio corresponding to the molar ratio of the number of isocyanate groups (NCO) to the number of hydroxyl groups (OH) carried respectively by the combined polyisocyanate(s) and polyol(s) present in the reaction medium of stage E1.

In the context of the invention, and unless otherwise mentioned, r₂ is the NCO/OH molar ratio corresponding to the molar ratio of the number of isocyanate groups to the number of hydroxyl groups carried respectively by the combined isocyanate(s) (concerning in particular the polyurethane having NCO end groups and optionally the polyisocyanate(s) which have not reacted on conclusion of stage E1) and compound(s) of formula (III) present in the reaction medium of stage E2.

### Stage E1

### Polyol(s)

The polyol(s) which can be used according to the invention is (are) preferably chosen from polyether polyols, polyester polyols, polydiene polyols, polycarbonate polyols and their mixtures.

The polyol(s) which can be used to prepare the polyurethane having NCO end groups used according to the invention can be chosen from those for which the number-average molecular mass ranges from 200 to 20 000 g/mol, preferably from 250 to 18 000 g/mol and better still from 2000 to 12 000 g/mol.

Preferably, their hydroxyl functionality ranges from 2 to 3. The hydroxyl functionality is the mean number of hydroxyl functional groups per mole of polyol.

Preferably, the polyol(s) which can be used according to the invention exhibits (exhibit) a hydroxyl number (OHN) ranging from 9 to 105 mg KOH/g, and preferably from 13 to 90 mg KOH/g, more preferentially from 25 to 70 mg KOH/g and better still from 40 to 65 mg KOH/g of polyol.

The polyether polyol(s) which can be used according to the invention is (are) preferably chosen from polyoxyalkylene polyols, the linear or branched alkylene part of which comprises from 1 to 4 carbon atoms, preferably from 2 to 3 carbon atoms.

More preferentially, the polyether polyol(s) which can be used according to the invention is (are) preferably chosen from polyoxyalkylene diols or polyoxyalkylene triols and better still polyoxyalkylene diols, the linear or branched alkylene part of which comprises from 1 to 4 carbon atoms, preferably from 2 to 3 carbon atoms, and the number-average molar mass of which ranges from 200 to 20 000 g/mol and preferably from 2000 to 12 000 g/mol.

Mention may be made, as examples of polyoxyalkylene diols or triols which can be used according to the invention, of:
polyoxypropylene diols or triols (also denoted by polypropylene glycol (PPG) diols or triols) having a number-average molecular mass ranging from 400 to 18 000 g/mol and preferably ranging from 400 to 4000 g/mol;
polyoxyethylene diols or triols (also denoted by polyethylene glycol (PEG) diols or triols) having a number-average molecular mass ranging from 400 to 18 000 g/mol and preferably ranging from 400 to 4000 g/mol;
PPG/PEG copolymer diols or triols having a number-average molecular mass ranging from 400 to 18 000 g/mol and preferably ranging from 400 to 4000 g/mol;
polytetrahydrofuran (PolyTHF) diols or triols having a number-average molecular mass ranging from 250 to 4000 g/mol;
and their mixtures.

Preferably, the polyether polyol(s) which can be used is (are) chosen from polyoxypropylene diols or triols with a polydispersity index ranging from 1 to 1.4, in particular ranging from 1 to 1.3. This index corresponds to the ratio of the weight-average molar mass to the number-average molecular mass of the polyether polyol (PI=Mw/Mn), determined by GPC.

The abovementioned polyester polyols can be prepared conventionally and are widely available commercially. They can be obtained by polymerization of the corresponding alkylene oxide in the presence of a catalyst based on a double metal/cyanide complex.

Mention may be made, as examples of polyether diols, of the polyoxypropylene diols sold under the name “Acclaim®” by Bayer, such as “Acclaim® 12200”, with a number-average molecular mass in the vicinity of 11 335 g/mol and the hydroxyl number of which ranges from 9 to 11 mg KOH/g, “Acclaim® 8200”, with a number-average molecular mass in the vicinity of 8057 g/mol and the hydroxyl number of which ranges from 13 to 15 mg KOH/g, and “Acclaim® 4200”, with a number-average molecular mass in the vicinity of 4020 g/mol and the hydroxyl number of which ranges from 26.5 to 29.5 mg KOH/g, or else the polyoxypropylene diol sold under the name “Voranol P2000” by Dow, with a number-average molecular mass in the vicinity of 2004 g/mol and the hydroxyl number of which is 56 mg KOH/g approximately.

Mention may be made, as example of polyether triols, of the polyoxypropylene triol sold under the name “Voranol CP3355” by Dow, with a number-average molecular mass in the vicinity of 3554 g/mol and the hydroxyl number of which ranges from 40 to 50 mg KOH/g.

The polydiene polyol(s) which can be used according to the invention is (are) preferably chosen from polydienes comprising hydroxyl end groups, and their corresponding hydrogenated or epoxidized derivatives.

More preferentially, the polydiene polyol(s) which can be used according to the invention is (are) chosen from polybutadienes comprising hydroxyl end groups, which are optionally hydrogenated or epoxidized.

Better still, the polydiene polyol(s) which can be used according to the invention is (are) chosen from butadiene homopolymers comprising hydroxyl end groups, which are optionally hydrogenated or epoxidized.

The term “end” is understood to mean that the hydroxyl groups are located at the ends of the main chain of the polydiene polyol.

The abovementioned hydrogenated derivatives can be obtained by complete or partial hydrogenation of the double bonds of a polydiene containing hydroxyl end groups, and are thus saturated or unsaturated.

The abovementioned epoxidized derivatives can be obtained by chemoselective epoxidation of the double bonds of the main chain of a polydiene comprising hydroxyl end groups, and thus comprise at least one epoxy group in its main chain.

Mention may be made, as examples of polybutadiene polyols, of saturated or unsaturated butadiene homopolymers, comprising hydroxyl end groups, which are optionally epoxidized, such as, for example, those sold under the name Poly BD® or Krasol® by Cray Valley.

The polyester polyols can be chosen from polyester diols and polyester triols, and preferably from polyester diols.

Mention may be made, among the polyester polyols, for example, of:

polyester polyols of natural origin, such as castor oil;

polyester polyols resulting from the condensation of:
one or more aliphatic (linear, branched or cyclic) or aromatic polyols, such as, for example, ethanediol, 1,2-propanediol, 1,3-propanediol, glycerol, trimethylolpropane, 1,6-hexanediol, 1,2,6-hexanetriol, butenediol, sucrose, glucose, sorbitol, pentaerythritol, mannitol, triethanolamine, N-methyldiethanolamine and their mixtures, with
one or more polycarboxylic acids or an ester or anhydride derivative thereof, such as 1,6-hexanedioic acid, dodecanedioic acid, azelaic acid, sebacic acid, adipic acid, 1,18-octadecanedioic acid, phthalic acid, succinic acid and the mixtures of these acids, an unsaturated anhydride, such as, for example, maleic or phthalic anhydride, or a lactone, such as, for example, caprolactone.

The abovementioned polyester polyols can be prepared conventionally and are for the most part commercially available.

Mention may be made, among the polyester polyols, for example, of the following products with hydroxyl functionality equal to 2:
Tone® 0240 (available from Union Carbide), which is a polycaprolactone with a number-average molecular mass of approximately 2000 g/mol and a melting point of approximately 50° C.,
Dynacoll® 7381 (available from Evonik) with a number-average molecular mass of approximately 3500 g/mol and a melting point of approximately 65° C.,
Dynacoll® 7360 (available from Evonik), which results from the condensation of adipic acid with hexanediol, and has a number-average molecular mass of approximately 3500 g/mol and a melting point of approximately 55° C.,
Dynacoll® 7330 (available from Evonik) with a number-average molecular mass of approximately 3500 g/mol and a melting point of approximately 85° C.,
Dynacoll® 7363 (available from Evonik), which also results from the condensation of adipic acid with hexanediol, and has a number-average molecular mass of approximately 5500 g/mol and a melting point of approximately 57° C.,
Dynacoll® 7250 (sold by EVONIK): polyester polyol having a viscosity of 180 Pa·s at 23° C., a number-average molecular mass Mn equal to 5500 g/mol and a T_{g} equal to −50° C.,
Kuraray® P-6010 (sold by Kuraray): polyester polyol having a viscosity of 68 Pa·s at 23° C., a number-average molecular mass equal to 6000 g/mol and a T_{g} equal to −64° C.,
Kuraray® P-10010 (sold by Kuraray): polyester polyol having a viscosity of 687 Pa·s at 23° C. and a number-average molecular mass equal to 10 000 g/mol.

Mention may also be made, as example of polyester diol, of Realkyd® XTR 10410, sold by Cray Valley, with a number-average molecular mass (Mn) in the vicinity of 1000 g/mol and the hydroxyl number of which ranges from 108 to 116 mg KOH/g. It is a product resulting from the condensation of adipic acid, diethylene glycol and monoethylene glycol.

The polycarbonate polyols can be chosen from polycarbonate diols or triols, especially having a number-average molecular mass (Mₙ) ranging from 300 g/mol to 12 000 g/mol, preferably ranging from 400 to 4000 g/mol.

Mention may be made, as examples of polycarbonate diol, of:
Converge Polyol 212-10 and Converge Polyol 212-20, sold by Novomer, respectively with number-average molecular masses (Mₙ) equal to 1000 and 2000 g/mol, the hydroxyl numbers of which are respectively 112 and 56 mg KOH/g,
Desmophen® C XP 2716, sold by Covestro, with a number-average molecular mass (Mₙ) equal to 326 g/mol, the hydroxyl number of which is 344 mg KOH/g,
Polyol C-590, C1090, C-2090 and C-3090, sold by Kuraray, having a number-average molecular mass (Mₙ) ranging from 500 to 3000 g/mol and a hydroxyl number ranging from 224 to 37 mg KOH/g.

Preferably, the reaction E1 is carried out in the presence of polyol(s) chosen from polyether polyols, preferably polyether diols and/or polyether triols.

### Polyisocyanate(s)

The polyisocyanate(s) are preferably diisocyanate(s) preferably chosen from the following diisocyanates:
a1) pentamethylene diisocyanate (PDI),
a2) hexamethylene diisocyanate (HDI),
a3) isophorone diisocyanate (IPDI),
a4) 2,4-toluene diisocyanate (2,4-TDI),
a5) 2,4′-diphenylmethane diisocyanate (2,4′-MDI),
a6) meta-xylylene diisocyanate (m-XDI),
a7) 1,3-bis(isocyanatomethyl)cyclohexane (m-H6XDI),
a8) 4,4′-methylenedicyclohexyl diisocyanate (H12MDI),
a9) and their mixtures.

According to one embodiment, the diisocyanate is 2,4-TDI or consists essentially of 2,4-TDI.

According to another embodiment, the diisocyanate is m-XDI.

The polyisocyanate(s) (especially diisocyanate(s)) which can be used according to the invention (for example cited in a4) and a5) above) can be employed in the form of a mixture essentially containing said polyisocyanate(s) (respectively diisocyanate(s)) and a low content of residual polyisocyanate (respectively diisocyanate) compound(s) resulting from the synthesis of said polyisocyanate(s) (respectively diisocyanate(s)). The content of residual polyisocyanate (respectivement diisocyanate) compound(s) tolerated (corresponding in particular to the isomers of 2,4-TDI and of 2,4′-MDI respectively) is such that the use of said mixture in the preparation of the polyurethane having NCO end groups used according to the invention advantageously has no impact on the final properties of said polyurethane.

For example, the polyisocyanate(s) (for example diisocyanate(s)) which can be used according to the invention (in particular cited in a4) and a5) above) can be employed in the form of a mixture containing at least 99% by weight of polyisocyanate(s) (respectively diisocyanate(s)) and less than 1% by weight of residual polyisocyanate (respectively diisocyanate) compound(s), preferably in the form of a mixture containing at least 99.5% by weight of polyisocyanate(s) (respectively diisocyanate(s)) and less than 0.5% by weight of residual polyisocyanate (respectively diisocyanate) compound(s), more preferentially in the form of a mixture containing at least 99.8% by weight of polyisocyanate(s) (respectively diisocyanate(s)) and less than 0.2% by weight of residual polyisocyanate (respectively diisocyanate) compound(s), with respect to the weight of said mixture.

Preferably, the content of residual polyisocyanate (especially diisocyanate) compound(s) is such that the content by weight of isocyanate group in said mixture remains approximately equal to that indicated above with respect to the weight of the diisocyanate a4) and a5) alone.

Thus, the 2,4-TDI as cited in a4) can be employed in the form of a commercially available industrial TDI corresponding to a composition, the 2,4-TDI content of which is at least 99% by weight and preferably at least 99.5% by weight, with respect to the weight of said composition.

The 2,4′-MDI as cited in a5) can be employed in the form of a commercially available industrial MDI corresponding to a composition, the 2,4′-MDI content of which is at least 99% by weight and preferably at least 99.5% by weight, with respect to the weight of said composition.

Preferably, stage E1 is carried out in the presence of TDI and preferably of 2,4-TDI.

According to one embodiment, the present invention relates to a process for the preparation of an abovementioned polyurethane (PP2) comprising:
in a first stage (denoted E1), the preparation of a polyurethane having NCO end groups (PP1) by a polyaddition reaction:
   (i) of at least one diisocyanate chosen from the following diisocyanates:
a1) pentamethylene diisocyanate (PDI) (the percentage by weight of isocyanate group of which is equal to 55% by weight approximately, with respect to the weight of PDI),
a2) hexamethylene diisocyanate (HDI) (the percentage by weight of isocyanate group of which is equal to 50% by weight approximately, with respect to the weight of HDI),
a3) isophorone diisocyanate (IPDI) (the percentage by weight of isocyanate group of which is equal to 38% by weight approximately, with respect to the weight of IPDI),
a4) 2,4-toluene diisocyanate (2,4-TDI) (the percentage by weight of isocyanate group of which is equal to 48% by weight approximately, with respect to the weight of 2,4-TDI),
a5) 2,4′-diphenylmethane diisocyanate (2,4′-MDI) (the percentage by weight of isocyanate group of which is equal to 34% by weight approximately, with respect to the weight of 2,4′-MDI),
a6) meta-xylylene diisocyanate (m-XDI) (the percentage by weight of isocyanate group of which is equal to 45% by weight approximately, with respect to the weight of m-XDI),
a7) 1,3-bis(isocyanatomethyl)cyclohexane (m-H6XDI) (the percentage by weight of isocyanate group of which is equal to 43% by weight approximately, with respect to the weight of m-H6XDI),
a8) and their mixtures,
   (ii) with at least one polyol chosen from polyether polyols, polydiene polyols, polyester polyols, polycarbonate polyols and their mixtures, in amounts of diisocyanate(s) and of polyol(s) resulting in an NCO/OH molar ratio, denoted r₁, strictly of greater than 1, preferably ranging from 1.6 to 1.9, preferentially ranging from 1.65 to 1.85; and

in a second stage (denoted E2), the reaction of the product formed in the first stage E1 with at least one compound of formula (III) as defined above, in amounts such that the NCO/OH molar ratio, denoted r₂, is less than or equal to 1, preferably of between 0.9 and 1.0, preferably of between 0.95 and 1.0,

it being possible for the 2,4-toluene diisocyanate (2,4-TDI) to be used in the form of a mixture of TDI a4) comprising at least 99% by weight of 2,4-toluene diisocyanate (2,4-TDI), with respect to the total weight of said mixture a4), and

it being possible for the 2,4′-diphenylmethane diisocyanate (2,4′-MDI) to be used in the form of a mixture of MDI a5) comprising at least 99% by weight of 2,4′-diphenylmethane diisocyanate (2,4′-MDI), with respect to the total weight of said mixture a5).

The polyisocyanate(s) which can be used to prepare the polyurethane (PP2) according to the invention are typically widely available commercially. Mention may be made, by way of example, of “Scuranate® T100” sold by Vencorex, corresponding to a 2,4-TDI with a purity of greater than 99% by weight, “Desmodur® I” sold by Bayer, corresponding to an IPDI, “Takenate™ 500” sold by Mitsui Chemicals, corresponding to an m-XDI, “Takenate™ 600” sold by Mitsui Chemicals, corresponding to an m-H6XDI, or “Vestanat® H12MDI” sold by Evonik, corresponding to an H12MD1.

### Conditions

Stage E1 can be carried out at a temperature T1 of less than 95° C. and preferably under anhydrous conditions.

When the polyisocyanate used during stage E1 is in the form of a composition or mixture as described above, the calculation of the ratio r₁ takes into account, on the one hand, the NCO groups carried by the polyisocyanate and the residual polyisocyanate compounds resulting from the synthesis of said polyisocyanate(s) optionally present as a mixture and, on the other hand, the OH groups carried by the polyol(s) present in the reaction medium of stage E1.

The polyaddition reaction of stage E1 can be carried out in the presence or absence of at least one reaction catalyst.

The reaction catalyst(s) which can be used during the polyaddition reaction of stage E1 can be any catalyst known to a person skilled in the art for catalyzing the formation of polyurethane by reaction of at least one polyisocyanate with at least one polyol preferably chosen from polyether polyols, polyester polyols and polydiene polyols.

An amount ranging up to 0.3% by weight of catalyst(s), with respect to the weight of the reaction medium of stage E1, can be used. In particular, it is preferable to use from 0.02% to 0.2% by weight of catalyst(s), with respect to the weight of the reaction medium of stage E1.

Preferably, the polyurethane having NCO end groups (PP1) is obtained by polyaddition of at least one diisocyanate, preferably of one or two diisocyanates, chosen from those cited in a1), a2), a3), a4), a5), a6) and a7), as described in any one of the preceding sections.

According to a preferred embodiment, the polyurethane having NCO end groups (PP1) is obtained by polyaddition of at least one diisocyanate, preferably of one or two diisocyanates, chosen from those cited in a1), a2), a3), a4), a5), a6) and a7), as described in any one of the preceding sections, with at least one, preferably one or two, polyol(s) chosen from polyether polyols and polydiene polyols, and preferably polyether polyols, such as, for example, polyether diols and/or polyether triols.

According to a preferred embodiment, the polyurethane having NCO end groups (PP1) is obtained by polyaddition of at least one diisocyanate, preferably of one or two diisocyanates, chosen from those cited in a1), a2), a3), a4), a5), a6) and a7), as described in any one of the preceding sections, with at least one, preferably one or two, polyol(s) chosen from polyether polyols, in the presence of at least one reaction catalyst, at a reaction temperature T1 of less than 95° C. and preferably ranging from 65° C. to 80° C., and in amounts of diisocyanate(s) and of polyether polyol(s) resulting in an NCO/OH molar ratio, r₁, strictly of greater than 1, preferably ranging from 1.6 to 1.9 and preferentially from 1.65 to 1.85.

Preferably, the polyurethane having NCO end groups (PP1) is obtained by polyaddition of 2,4-TDI with at least one polyol chosen from polyether polyol(s), in the presence of at least one reaction catalyst, at a reaction temperature T1 of less than 95° C. and preferably ranging from 65° C. to 80° C., and in amounts of diisocyanate(s) and of polyether diol(s) and/or triol(s) resulting in an NCO/OH molar ratio, denoted r₁, strictly of greater than 1, preferably ranging from 1.6 to 1.9 and preferentially from 1.65 to 1.85.

More preferably, the polyurethane having NCO end groups (PP1) is obtained by polyaddition of 2,4-TDI with a polyol chosen from polyether diols or triols, and preferably with a polyether diol, in the presence of at least one reaction catalyst, at a reaction temperature T1 of less than 95° C. and preferably ranging from 65° C. to 80° C., and in amounts of diisocyanate(s) and of polyether diol(s) or triol(s) resulting in an NCO/OH molar ratio, denoted r₁, strictly of greater than 1, preferably ranging from 1.6 to 1.9 and preferentially from 1.65 to 1.85.

On conclusion of stage E1, the polyurethane having NCO end groups (PP1) obtained is such that the content of NCO groups (also designated by “degree of NCO” and denoted % NCO) present in the reaction medium of stage E1 preferably ranges from 0.5% to 5.7%, more preferentially from 0.7% to 3% and better still from 1% to 2.5%, with respect to the weight of the reaction medium of stage E1.

“Content of NCO groups” (also designated by “degree of NCO”, denoted % NCO) is understood to mean the content of isocyanate groups carried by the combined compounds present in the reaction medium, namely the polyurethane having NCO end groups (PP1) formed and the other entities carrying isocyanate group(s) present, such as unreacted polyisocyanate monomers. This content of NCO groups can be calculated in a way well known to a person skilled in the art and is expressed as a percentage by weight with respect to the total weight of the reaction medium.

### Stage E2

According to one embodiment, stage E2 is carried out at a temperature of less than 95° C. and preferably under anhydrous conditions.

Stage E2 can be carried out with a compound of formula (III) or with a mixture of compounds of formula (III) of different natures.

The abovementioned compound(s) of formula (III) can be used either pure or in the form of a mixture or a composition preferably containing at least 95% by weight of compound(s) of formula (III).

Stage E2) can be carried out with a mixture of compounds of formula (II) of different natures (for example with different R¹ groups, or else different R² groups, or else with different R¹ and R² groups).

Mention may be made, by way of example of compound of formula (II), of 4-hydroxymethyl-5-methyl-1,3-dioxolen-2-one available from Fluorochem and Oxchem, having a molar mass of 130.1 g/mol and a hydroxyl number in the vicinity of 431 mg KOH/g.

The calculation of the ratio r₂ in particular takes into account, on the one hand, the NCO groups carried by all of the isocyanates present in the reaction medium during stage E2 (polyurethane having NCO end groups and optionally the unreacted polyisocyanates which were used in its synthesis resulting from stage E1) and, on the other hand, the OH groups carried by the compound(s) of formula (III).

On conclusion of stage E2, the reaction medium is preferably devoid of potentially toxic diisocyanate monomers (IPDI, TDI, MDI). In this case, the polyurethane (PP2) according to the invention advantageously does not present toxicological risks related to the presence of such monomers.

On conclusion of stage E2, the abovementioned polyurethane (PP2) preferably exhibits from 0.1 to 1.5 milliequivalents of functional groups T of abovementioned formula (I) per gram of said polyurethane (PP2), more preferentially from 0.15 to 1 milliequivalent of functional groups T per gram of said polyurethane (PP2) and better still from 0.2 to 0.8 milliequivalent of functional groups T per gram of said polyurethane (PP2).

### Other Stages

The abovementioned process can comprise a stage of purification of the intermediate reaction products.

Preferably, the process does not comprise a stage of purification of the intermediate reaction products or a stage of removal of solvent.

According to one embodiment, said process does not comprise a stage consisting in adding one or more solvent(s) and/or plasticizer(s). Such a preparation process can thus be advantageously carried out without interruption, with very high production line speeds on the industrial scale.

According to a preferred embodiment, the process according to the invention consists of a first stage E1 and of a second stage E2, as defined in any one of the preceding sections.

Another subject matter of the present invention is a polyurethane having comprising at least two end functional groups T of formula (I) (PP2) capable of being obtained according to a preparation process according to the invention, as described in any one of the preceding sections.

### C. Multicomponent System

Another subject matter of the present invention is a multicomponent system, preferably a solvent-free multicomponent system, comprising:
as first component (component A), a composition comprising at least one polyurethane (PP2) as defined above, and
as second component (component B), a composition comprising at least one amino compound (B1) comprising at least two amine groups chosen from primary amine groups, secondary amine groups and their mixtures, preferably comprising at least two primary amine groups.

The components of the multicomponent system are generally stored separately and are mixed at the time of use, at a mixing temperature T3, in order to form a composition, preferably an adhesive composition, intended to be applied to the surface of a material.

The mixing of the components of the multicomponent system and in particular of the components A and B can be carried out under anhydrous conditions.

Preferably, the amounts of polyurethane(s) (PP2) and of amino compound(s) (B1) present in the multicomponent system according to the invention result in a molar ratio of the number of functional groups T of formula (I) to the number of primary and/or secondary amine groups, denoted r₃, ranging from 0.5 to 1.

The molar ratio, denoted r₃, in the whole of the present patent application corresponds to the molar ratio of the total number of functional groups T of formula (I) present in the multicomponent system to the total number of primary and/or secondary amine groups present in the multicomponent system.

The use of such a ratio r₃ advantageously makes it possible to obtain, by a polyaddition reaction between the abovementioned polyurethane(s) (PP2) and the amino compound(s) (B1) preferably comprising at least two or three primary amine groups according to the invention, a composition, preferably an adhesive composition, advantageously exhibiting good mechanical performance qualities.

The amino compound(s) (B1) used according to the invention preferably has (have) a viscosity suited to the mixing temperature T3.

The amino compound(s) (B1) used according to the invention preferably has (have) a primary alkalinity ranging from 0.4 to 34 meq/g, more preferentially from 3.0 to 34 meq/g, of amino compound.

The primary alkalinity is the number of primary amine NH₂ functional groups per gram of amino compound (B1), said number being expressed in the form of milliequivalents of HCl (or milliequivalents of NH₂) used in the assaying of the amine functional groups, determined in a well-known way by titrimetry.

The amino compound(s) (B1) used according to the invention can be monomeric or polymeric compounds.

The amino compound(s) (B1) can additionally comprise tertiary amine groups.

The amino compound(s) (B1) used according to the invention can be chosen from saturated or unsaturated and linear, branched, cyclic or acyclic hydrocarbon compounds comprising at least two amine groups chosen from primary amine groups, secondary amine groups and their mixtures, preferably comprising at least two primary amine —NH₂ groups, the hydrocarbon chain between the amine (or advantageously —CH₂—NH₂) functional groups optionally being interrupted by one or more heteroatoms chosen from 0, N or S and/or optionally interrupted by one or more divalent —NH— (secondary amine), —COO— (ester), —CONH— (amide), —NHCO— (carbamate), —C═N— (imine), —CO— (carbonyl) and —SO— (sulfoxide) groups, said amino compound(s) preferably exhibiting a primary alkalinity ranging from 0.4 to 34 meq/g, more preferably, from 3.0 to 34 meq/g, of amino compound.

Mention may be made, as examples of such compounds, for example, of:
alkylenepolyamines comprising at least two primary amine —NH₂ groups,
cycloalkylenepolyamines comprising at least two primary amine —NH₂ groups,
polyamines comprising both alkyl and cycloalkyl groups and comprising at least two primary amine —NH₂ groups,
polyether polyamines comprising at least two primary amine —NH₂ groups,
polyethyleneimines comprising at least two primary amine —NH₂ groups,
polypropyleneimines comprising at least two primary amine —NH₂ groups,
polyamidoamines comprising at least two primary amine —NH₂ groups.

Preferably, the amino compound(s) (B1) used according to the invention has (have) two or three primary amine groups.

More preferentially, the amino compound(s) (B1) used according to the invention is (are) chosen from saturated and linear, branched, cyclic or acyclic hydrocarbon compounds comprising two or three primary amine —NH₂ groups, said compounds optionally being interrupted by one or more heteroatoms chosen from an oxygen —O— atom and a nitrogen —N— atom and/or one or more divalent secondary amine —NH— groups, and exhibiting a primary alkalinity ranging from 0.4 to 34 meq/g, more preferentially from 3.0 to 34 meq/g, of amino compound.

Mention may be made, as examples of such compounds, for example, of:
alkylenediamines and alkylenetriamines, respectively comprising two or three primary amine —NH₂ groups,
cycloalkylenediamines and cycloalkylenetriamines, respectively comprising two or three primary amine —NH₂ groups,
diamines and triamines comprising both alkyl and cycloalkyl groups, respectively comprising two or three primary amine —NH₂ groups,
polyether diamines and polyether triamines, respectively comprising two or three primary amine —NH₂ groups,
polyethyleneimines comprising two or three primary amine —NH₂ groups,
polypropyleneimines comprising two or three primary amine —NH₂ groups,
polyamidoamines comprising two or three primary amine —NH₂ groups.

More particularly, mention may be made of:
ethylenediamine (EDA) having a primary alkalinity of 33.28 meq/g:

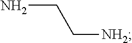

diethylenetriamine (DETA) having a primary alkalinity of 19.39 meq/g:

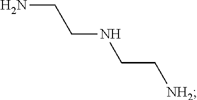

tris(2-aminoethyl)amine (TAEA) having a primary alkalinity of 20.52 meq/g:

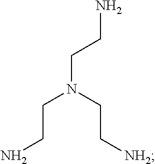

polyethyleneimines corresponding to the formulae below:

H₂N—(CH₂—CH₂—NH)ₓ—CH₂—CH₂—NH₂

N[—(CH₂—CH₂—NH)ₓ—CH₂—CH₂—NH₂]₃
in which x is an integer such that the primary alkalinity ranges from 0.4 to 34 meq/g, more preferentially from 3.0 to 34 meq/g;
polypropyleneimines corresponding to the formulae below:

H₂N—(CH₂—CH₂—CH₂—NH)ₓ—CH₂—CH₂—CH₂—NH₂

N[—CH₂—CH₂—CH₂—NH)ₓ—CH₂—CH₂—CH₂—NH₂]₃
in which x is an integer such that the primary alkalinity ranges from 0.4 to 34 meq/g, more preferentially from 3.0 to 34 meq/g;
poly(ethylene-propylene)imines corresponding to the formulae below:

H₂N—(CH₂—CH₂—NH)ₓ—(CH₂—CH₂—CH₂—NH)_{y}H

N[—(CH₂—CH₂—NH)ₓ—(CH₂—CH₂—CH₂—NH)_{y}H]₃
in which x and y are integers such that the primary alkalinity ranges from 0.4 to 34 meq/g, more preferentially from 3.0 to 34 meq/g;
hexamethylenediamine (NMDA) having a primary alkalinity of 17.11 meq/g:

NH₂—CH₂—CH₂—CH₂—CH₂—CH₂—CH₂—NH₂;
isophoronediamine (IPDA) having a primary alkalinity of 11.73 meq/g:

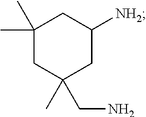

polyether diamines having a primary alkalinity ranging from 11.4 to 13.5 meq/g and corresponding to the formula below:

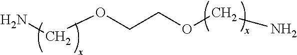

in which x=2 or 3; such polyether diamines are sold, for example, under the names Jeffamines EDR-148 and EDR-176 by Huntsman and exhibit respective primary alkalinities of 13.5 and 11.4 meq/g;
polyether diamines having a primary alkalinity ranging from 0.5 to 8.7 meq/g and corresponding to the formula below:

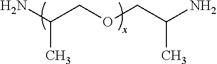

in which x is an integer ranging from 2 to 68, such that the primary alkalinity ranges from 0.5 to 8.7 meq/g; such polyether diamines are sold, for example, under the names Jeffamines D-230, D-400, D-2000 and D-4000 by Huntsman and exhibit respective primary alkalinities of 8.7, 5.0, 1.0 and 0.5 meq/g;
polyether diamines having a primary alkalinity ranging from 1.0 to 9.1 meq/g and corresponding to the formula below:

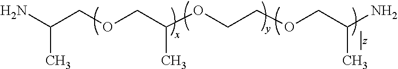

in which x, y and z are integers, y ranging from 2 to 39 and x+z ranging from 1 to 6, such that the primary alkalinity ranges from 1.0 to 9.1 meq/g; such polyether diamines are sold, for example, under the names Jeffamines HK-511, ED-600, ED-900 and ED-2003 by Huntsman and exhibit respective primary alkalinities of 9.1, 3.3, 2.2 and 1.0 meq/g;
polyether triamines having a primary alkalinity ranging from 0.6 to 6.8 meq/g and corresponding to the formula below:

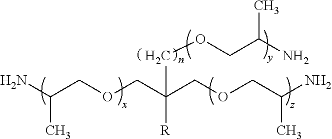

in which R is a hydrogen atom or a C₁ to C₂ alkyl group, x, y, z and n are integers, n ranging from 0 to 1 and x+y+z ranging from 5 to 85, such that the primary alkalinity ranges from 0.6 to 6.8 meq/g; such polyether diamines are sold, for example, under the names Jeffamines T-403, T-3000 and T-5000 by Huntsman and exhibit respective primary alkalinities of 6.8, 1.0 and 0.6 meq/g;
dimeric and trimeric fatty amines comprising two or three primary amine groups with a primary alkalinity ranging from 3.39 meq/g to 3.60 meq/g. These dimeric and trimeric fatty amines can be obtained from corresponding dimerized and trimerized fatty acids. Mention may be made, as examples of such dimeric fatty amines, of those corresponding to the following formulae:

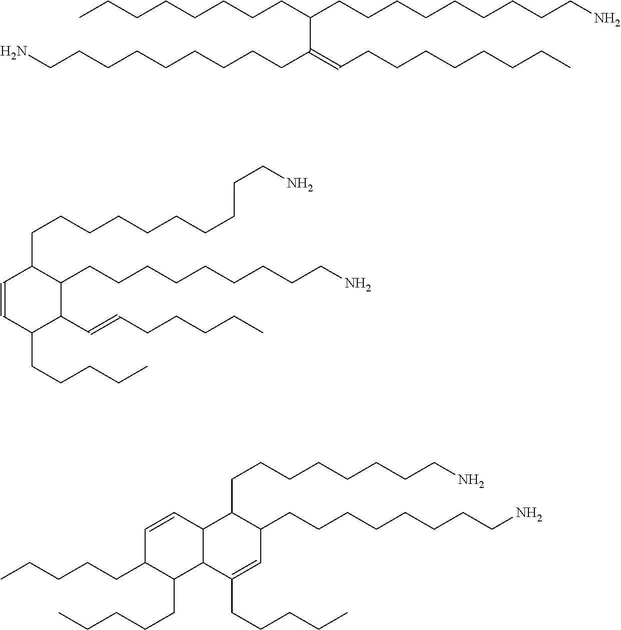 [SMILES: CCCCCCCC/C=C(/CCCCCCCCCN)C(CCCCCCCC)CCCCCCCCCN ; CCCCC/C=C/C1C(CCCCC)C=CC(CCCCCCCCCCN)C1CCCCCCCCCN ; CCCCCC1=CC(CCCCCCCCN)C(CCCCCCCCN)C2C=CC(CCCCC)C(CCCCC)C12]

The dimeric and trimeric fatty acids used to prepare the abovementioned fatty amines are obtained by high-temperature polymerization under pressure of unsaturated fatty monocarboxylic acids (monomeric acid) comprising from 6 to 22 carbon atoms, preferably from 12 to 20 carbon atoms, and originate from plant or animal sources. Mention may be made, as examples of such unsaturated fatty acids, of 018 acids having one or two double bonds (respectively oleic acid or linoleic acid) obtained from tall oil, which is a byproduct of the manufacture of paper pulp. After polymerization of these unsaturated fatty acids, an industrial mixture is obtained which contains, on average, 30-35% by weight of fatty monocarboxylic acids, often isomerized, with respect to the starting unsaturated fatty monocarboxylic acids, 60-65% by weight of dicarboxylic acids (dimeric acids) comprising twice the carbon number, with respect to the starting unsaturated fatty monocarboxylic acids, and 5-10% by weight of tricarboxylic acids (trimeric acids) having three times the carbon number, with respect to the starting unsaturated fatty monocarboxylic acids. The different commercial grades of dimeric, monomeric or trimeric acids are obtained by purification of this mixture. These dimeric and trimeric fatty acids are subsequently subjected to a reductive ammoniation (NH₃/H₂) reaction in the presence of a catalyst, making it possible to obtain the dimerized fatty amines.

According to one embodiment, the compound(s) (B1) comprise at least two methyleneamine (—CH₂—NH₂) groups.

According to a preferred embodiment, the compound(s) (B1) are chosen from tris(2-aminoethyl)amine (TAEA), hexamethylenediamine (NMDA) and their mixtures.

When the multicomponent system according to the invention comprises at least two amino compounds (B1), the latter can be included in two different components, for example a component (B) and a component (C). The components (A), (B) and (C) are then stored separately before mixing at the time of the use of said system, at a mixing temperature T3, in order to form a composition, preferably an adhesive composition, intended to be applied to the surface of a material.

The multicomponent system according to the invention can comprise at least one crosslinking catalyst.

The crosslinking catalyst(s) can be any catalyst generally used to accelerate the ring-opening reaction of a compound comprising a functional group T by a primary and/or secondary amine.

Mention may be made, as examples of crosslinking catalysts which can be used according to the invention, of:
alkoxides, such as potassium tert-butoxide or sodium methoxide;
strong bases chosen from:
   phosphazenes, such as 2-(tert-butylimino)-2-diethylamino-1,3-dimethylperhydro-1,3,2-diazaphosphorine (BMEP),
   guanidines, such as:

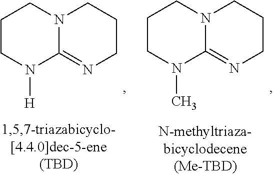

tertiary amines, such as:

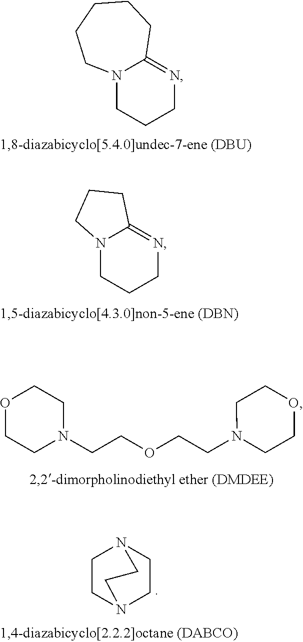 [SMILES: C1CCC2=NCCCN2CC1 ; C1CN=C2CCCN2C1 ; C1CN(CCOCCN2CCOCC2)CCO1 ; C1CN2CCN1CC2]

An amount ranging from 0.05 to 1% by weight of crosslinking catalyst(s), with respect to the total weight of the multicomponent system according to the invention, can be used.

The crosslinking catalyst(s) can be distributed in one or more of the components forming the multicomponent system according to the invention.

Advantageously, the multicomponent system according to the invention can comprise at least one inorganic filler.

The inorganic filler(s) which can be used is (are) advantageously chosen so as to improve the mechanical performance qualities of the composition according to the invention in the crosslinked state.

Mention may be made, as examples of fillers which can be used, in a nonlimiting way, of calcium carbonate, kaolin, silica, gypsum, microspheres and clays.

Preferably, the inorganic filler(s) has (have) a maximum particle size, in particular an external diameter, of less than 100 μm and preferably of less than 10 μm. Such fillers can be selected, in a way well known to a person skilled in the art, by using sieves having appropriate meshes.

Preferably, the total content of filler(s) optionally present in the multicomponent system according to the invention does not exceed 70% by weight of the total weight of said system.

The filler(s) can be distributed in one or more of the components forming the multicomponent system according to the invention.

The multicomponent system according to the invention can include less than 2% by weight of one or more additives advantageously appropriately chosen in order not to damage the properties of the composition according to the invention in the crosslinked state. Mention may be made, among the additives which can be used, of UV (ultraviolet) stabilizers or antioxidants, pigments and dyes. These additives are preferably chosen from those generally used in adhesive compositions.

The additive(s) can be distributed in one or more of the components forming the multicomponent system according to the invention.

Preferably, the abovementioned multicomponent system does not comprise solvent and/or plasticizer.

As a result of the low viscosity of the polyurethane (PP2) according to the invention, the multicomponent system according to the invention can advantageously be employed directly by mixing its different components, without addition of solvent and/or of plasticizer, viscosity reducers, to the component (A) and/or without heating said component to temperatures above 95° C.

Preferably, the polyurethane (PP2) according to the invention has a viscosity, measured at 23° C., of less than or equal to 600 Pa·s and a viscosity, measured at 60° C., of less than or equal to 40 Pa·s, allowing the multicomponent system according to the invention to be advantageously employed without addition of solvent and/or of plasticizer to the component (A) comprising said polyurethane (PP2) and/or without heating said component.

According to one embodiment, the multicomponent system according to the invention comprises:
as first component (A), a composition comprising at least one polyurethane (PP2) according to the invention and
as second component (B), a composition comprising at least one or two amino compound(s) as described in one of the preceding sections (B1), and

said multicomponent system being devoid of solvent and/or of plasticizer.

The multicomponent system according to the invention can be a two-component system, that is to say a system consisting of two components (A) and (B), said components (A) and (B) being as described in one of the preceding sections.

Preferably, the component (A) comprises at least 97% by weight and more preferentially at least 98% by weight of polyurethane (PP2) according to the invention, with respect to the total weight of said component (A).

According to one embodiment, the multicomponent system is an adhesive composition, preferably a glue or mastic composition.

The invention also relates to the use of a polyurethane (PP2) according to the invention in the manufacture of an adhesive composition, preferably a solvent-free adhesive composition, in particular in the form of a multicomponent system.

Preferably, the adhesive composition is manufactured without addition of compound intended to lower the viscosity of said composition, such as a solvent (aqueous, organic), a reactive diluent and/or a plasticizer.

Preferably, the components of the multicomponent system according to the invention comprising the polyurethane(s) (PP2) according to the invention and the amino compound(s) (B1) according to the invention are mixed at a temperature T3 as defined above.

Preferably, the composition, preferably adhesive composition, according to the invention is manufactured by the use of the multicomponent system according to the invention, that is to say the mixing of the different components constituting it, at a mixing temperature T3.

### D. Uses

Another subject matter of the invention is a process for assembling materials employing the polyurethane (PP2) according to the invention, in particular via the use of the multicomponent system according to the invention, comprising the following stages:
the mixing of at least one polyurethane (PP2) as described above and of at least one amino compound (B1), then
the coating of said mixture onto the surface of a first material, then
the laminating of the surface of a second material onto said coated surface, then
the crosslinking of said mixture.

The stage of mixing at least one polyurethane (PP2) as described above and at least one amino compound (B1) as described above can be carried out in particular by the use of the multicomponent system according to the invention, namely by mixing the components respectively comprising the polyurethane(s) (PP2) (component (A)) and the amino compound(s) (component (B)), as are defined above.

This mixing stage can be carried out at room temperature or under hot conditions, before coating.

Preferably, the mixing is carried out at a temperature lower than the decomposition temperature of the ingredients included in one or other of the components (A) and (B). In particular, the mixing is carried out at a temperature T3 of less than 95° C., preferably ranging from 15 to 80° C., in order advantageously to avoid any thermal decomposition.

Preferably, the polyurethane having end groups (PP2) and the amino compound(s) (B1) are mixed in amounts such that the molar ratio of the number of functional groups T to the number of primary and/or secondary amine groups present in the mixture, denoted r₃, ranges from 0.5 to 1.

In each of these alternative forms, the coating of said mixture can be carried out over all or part of the surface of a material. In particular, the coating of said mixture can be carried out in the form of a layer with a thickness ranging from 0.002 to 5 mm.

Optionally, the crosslinking of said mixture on the surface of the material can be accelerated by heating the coated material(s) to a temperature of less than or equal to 120° C. The time required in order to complete this crosslinking reaction and to thus ensure the required level of cohesion is generally of the order of 0.5 to 24 hours.

The coating and the laminating of the second material are generally carried out within a time interval compatible with the coating process, as is well known to a person skilled in the art, that is to say before the adhesive layer loses its ability to fix the two materials by adhesive bonding.

The appropriate materials are, for example, inorganic substrates, such as glass, ceramics, concrete, metals or alloys (such as aluminum alloys, steel, nonferrous metals and galvanized metals), and also metals and composites which are optionally coated with paint (as in the motor vehicle field); or else organic substrates, like wood or plastics, such as PVC, polycarbonate, PMMA, epoxy resins and polyesters.

The present invention also relates to the use of a polyurethane comprising at least two end functional groups T of formula (I) (PP2) according to the invention in the manufacture of an adhesive composition.

The mechanical performance qualities and the adhesiveness of the compositions according to the invention can be measured in accordance with the tests described in the examples which follow, namely once crosslinked. The compositions according to the invention are advantageously suited to a broad panel of applications, such as the food processing industry, cosmetics, hygiene, transportation, housing, textiles or packaging. In particular, the compositions according to the invention exhibit an intrinsic elongation at break force ranging from 0.3 to 10 MPa, as illustrated in the examples (measurement of the mechanical performance qualities).

It has been observed that the polyurethane (PP2) according to the invention advantageously exhibits an improved reactivity with regard to amino compounds comprising at least two primary and/or secondary amine groups at a temperature close to ambient (ranging, for example, from 15° C. to 35° C.).

Furthermore, it has been observed that, by using the polyurethane (PP2) according to the invention, it was advantageously possible to manufacture solvent-free adhesive compositions exhibiting good wettability properties and good mechanical performance qualities, suited to surface coating, and satisfactory adhesive properties for the assembling by adhesive bonding of at least two materials.

All the embodiments described above can be combined with one another.

In the context of the invention, the term “of between x and y” or “ranging from x to y” is understood to mean an interval in which the limits x and y are included. For example, the range “of between 0% and 25%” includes in particular the values 0% and 25%.

The following examples are given purely by way of illustration of the invention and should not be interpreted in order to limit the scope thereof.

### Experimental Part

A—Synthesis of the Polyurethane Comprising at Least Two End Functional Groups T (PP2) (Component A)

The components (A) of examples 1 to 4 according to the invention are prepared using the reactants shown in table 1 and according to the procedure described in the following pages. The amounts shown in table 1 are expressed in grams of commercial products.

TABLE 1

| Ingredients | 1 | 2 | 3 | 4 |
|---|---|---|---|---|
| PPG diol | 80.8 | — | — | — |
| PPG triol | — | 83.1 | 83.1 | 83.1 |
| 2,4-TDI | 11.8 | 10.3 | 10.3 | 10.3 |
| Reaction catalyst | 0.1 | 0.1 | 0.1 | 0.1 |
| NCO/OH ratio, r₁ | 1.68 | 1.78 | 1.78 | 1.78 |
| 4-Hydroxymethyl-5-methyl- | 7.2 | 6.5 | 6.5 | 6.5 |
| 1,3-dioxolen-2-one | | | | |
| NCO/OH molar ratio, r₂ | 0.93 | 0.98 | 0.98 | 0.98 |

In table 1, use is made, as:
PPG diol, of the commercial product sold under the name Voranol® P2000 by Dow, corresponding to polypropylene glycol diol having a hydroxyl number approximately equal to 56 mg KOH/g,
PPG triol, of the commercial product sold under the name Voranol® CP3355 by Dow, corresponding to polypropylene glycol triol having a hydroxyl number approximately equal to 45 mg KOH/g,
2,4-TDI, of the commercial product sold under the name Scuranate® T100 by Vencorex, corresponding to a TDI composition comprising 99% by weight of 2,4-TDI,
reaction catalyst, of the commercial product sold under the name Borchi Kat® 315 by Borchers, corresponding to bismuth neodecanoate,
4-hydroxymethyl-5-methyl-1,3-dioxolen-2-one (CAS number: 91526-18-0), synthesized according to WO 96/02253, having a hydroxyl number approximately equal to 431 mg KOH/g.

The molar ratios r₁ and r₂ are calculated in a way well known by a person skilled in the art from the molar amounts of reactants used. By expressing the number of mole(s) of diisocyanate used as a function of the molar mass of the latter; the number of mole(s) of polyol used as a function of the hydroxyl number (mg KOH/g) and of the functionality of the latter; the number of mole(s) of 4-hydroxymethyl-5-methyl-1,3-dioxolen-2-one used as a function of the hydroxyl number (mg KOH/g) of the latter and knowing that the molar mass of KOH is 56.11 g/mol, it is possible to write:

$${r}_{1} = \frac{2 \times m 1 ( diisocyanate ) \times 1000 \times 56.11}{M ( diisocyanate ) \times OHN ( polyol ) \times m 2 ( polyol )}$$

$$and$$

$${r}_{2} = \frac{\frac{[ 2 \times m 1 ( diisocyanate ) ]}{M ( diisocyanate )} - \frac{[ OHN ( polyol ) \times m 2 ( polyol ) ]}{56}}{\begin{matrix}OHN ( 4 \text{-} hydroxymethyl \text{-} 5 \text{-} methyl \text{-} 1 , 3 \text{-} dioxolen \text{-} 2 \text{-} one ) \times \\ m 3 ( 4 \text{-} hydroxymethyl \text{-} 5 \text{-} methyl \text{-} 1 , 3 \text{-} dioxolen \text{-} 2 \text{-} one )\end{matrix}} \times 56.11$$

where:
m1 (diisocyanate) corresponds to the mass of Scuranate® T100 introduced,
M (diisocyanate) corresponds to the molar mass of TDI, which is equal to 174 g/mol,
OHN (polyol) corresponds to the hydroxyl number of the polyol used (Voranol® P2000 or Voranol® CP3355, according to the example considered),
m2 (polyol) corresponds to the mass of the polyol introduced,
OHN (4-hydroxymethyl-5-methyl-1,3-dioxolen-2-one) corresponds to the hydroxyl number of 4-hydroxymethyl-5-methyl-1,3-dioxolen-2-one,
m3 (4-hydroxymethyl-5-methyl-1,3-dioxolen-2-one) corresponds to the mass of 4-hydroxymethyl-5-methyl-1,3-dioxolen-2-one introduced.

Stage E1: Synthesis of the Polyurethane Having NCO End Groups (PP1)

The diisocyanate is heated to 50° C. in a reactor placed under a nitrogen atmosphere and then a mixture of polyol and of reaction catalyst, in accordance with the amounts shown in table 1, is introduced dropwise with continuous stirring, the reaction temperature T1 being controlled so that it does not exceed 80° C.

This mixture is kept continuously stirred at 80° C., under nitrogen, until the NCO functional groups of the diisocyanate have completely reacted.

The reaction is monitored by measuring the change in the content of NCO groups in the mixture, for example by back titration of dibutylamine using hydrochloric acid, according to the standard NF T52-132. The reaction is halted when the “degree of NCO” (% NCO) measured is approximately equal to the desired degree of NCO.

| | Characterization of the polyurethane | | | |
|---|---|---|---|---|
| | having NCO end groups (PP1) | | | |
| | 1 | 2 | 3 | 4 |
| % NCO calculated in the reaction | 2.5 | 2.3 | 2.3 | 2.3 |
| medium of stage E1 (as % by | | | | |
| weight of the weight of the | | | | |
| reaction medium) | | | | |

Stage E2: Synthesis of the Polyurethane (PP2) (Component A)

Once the reaction of stage E1 has finished, the 4-hydroxymethyl-5-methyl-1,3-dioxolen-2-one is introduced into the reactor in the proportions shown in table 1, with stirring and under nitrogen, care being taken that the reaction temperature T2 does not exceed 80° C. The polyurethane having NCO end groups (PP1)-4-hydroxymethyl-5-methyl-1,3-dioxolen-2-one mixture is kept continuously stirred at 80° C. under nitrogen until complete disappearance of the NCO functional groups visible in the infrared (IR) (approximately 2250 cm⁻¹).

Viscosity Measurement:

The viscosity of the component (A) obtained is measured 24 hours after the end of the reaction (D+1) at 23° C. and 60° C. and is expressed in pascal·seconds (Pa·s). All of the values measured for examples 1 to 4 are combined in the following table 2.

The viscosity measurement at 23° C. is carried out using a Brookfield RVT viscometer, with a spindle suited to the viscosity range and at a rotational speed of 20 revolutions per minute (rev/min).

The viscosity measurement at 60° C. is carried out using a Brookfield RVT viscometer coupled with a heating module of Thermosel type of the Brookfield brand, with a spindle suited to the viscosity range and at a rotational speed of 20 revolutions per minute.

TABLE 2

| | Characterization of the | | | |
|---|---|---|---|---|
| | polyurethane (PP2) | | | |
| | 1 | 2 | 3 | 4 |
| Viscosity at D + 1 at 23° C. | 380 | 1250 | 1250 | 1250 |
| (Pa · s) | | | | |
| Viscosity at D + 1 at 60° C. | 11.3 | 48.0 | 48.0 | 48.0 |
| (Pa · s) | | | | |
| Calculated content of functional | 0.56 | 0.50 | 0.50 | 0.50 |
| groups T in the polyurethane (PP2) | | | | |
| (meq/g of polyurethane (PP2)), | | | | |
| denoted t_{cc} (PP2) | | | | |

The content of functional groups T in the polyurethane (PP2) (denoted t_{cc} (PP2)) (expressed in meq/g of polyurethane (PP2)) is calculated in a way well known to a person skilled in the art from the molar amount of 4-hydroxymethyl-5-methyl-1,3-dioxolen-2-one introduced. By expressing the number of mole(s) of 4-hydroxymethyl-5-methyl-1,3-dioxolen-2-one introduced as a function of the hydroxyl number (mg KOH/g) of the latter and of the molar mass of KOH equal to 56.11 g/mol, it is possible to write:

$${t}_{c c} = \frac{\begin{matrix}OHN ( 4 \text{-} hydroxymethyl \text{-} 5 \text{-} methyl \text{-} 1 , 3 \text{-} dioxolen \text{-} 2 \text{-} one ) \times \\ m 3 ( 4 \text{-} hydroxymethyl \text{-} 5 \text{-} methyl \text{-} 1 , 3 \text{-} dioxolen \text{-} 2 \text{-} one )\end{matrix}}{56.11 \times m ( PP 2 )}$$

where:
OHN (4-hydroxymethyl-5-methyl-1,3-dioxolen-2-one) corresponds to the hydroxyl number of 4-hydroxymethyl-5-methyl-1,3-dioxolen-2-one,
m3 (4-hydroxymethyl-5-methyl-1,3-dioxolen-2-one) corresponds to the mass of 4-hydroxymethyl-5-methyl-1,3-dioxolen-2-one introduced,
m (PP2) corresponds to the mass of polyurethane (PP2), i.e. to the total mass of the ingredients used in the synthesis of the polyurethane (PP2) (PPG diol or triol, 2,4-TDI, reaction catalyst).

B—Preparation of the Adhesive Compositions by Mixing the Components (A) and (B)

The adhesive compositions 1′ to 4′ are prepared by mixing the different ingredients shown in the following table 3, the procedure described below being followed. The amounts shown in table 3 are expressed in grams.

TABLE 3

| | 1′ | 2′ | 3′ | 4′ |
|---|---|---|---|---|
| Component A of example 1 | 100 | — | — | — |
| Component A of example 2 | — | 100 | — | — |
| Component A of example 3 | — | — | 100 | — |
| Component A of example 4 | — | — | — | 100 |
| TAEA | 3.90 | 0.46 | 0.46 | — |
| HMDA | — | 3.48 | 3.48 | 3.48 |
| Calcium carbonate | 50 | — | 50 | 50 |
| Molar ratio r₃ | 0.7 | 0.7 | 0.7 | 0.6 |

In table 3, use is made of:
tris(2-aminoethyl)amine (TAEA) with a primary alkalinity=20.52 meq/g of TAEA,
hexamethylenediamine (HMDA) with a primary alkalinity=17.21 meq/g of HMDA,
calcium carbonate with a maximum particle size=100 μm.

The molar ratio r₃ is calculated in a way well known to a person skilled in the art from the molar amounts of 4-hydroxymethyl-5-methyl-1,3-dioxolen-2-one and of amino compound(s) having at least two primary amine (—NH₂) groups. By expressing the number of mole(s) of 4-hydroxymethyl-5-methyl-1,3-dioxolen-2-one as a function of the content of functional groups T in the polyurethane (PP2) calculated above and the number of mole(s) of amino compound(s) used as a function of the primary alkalinity (meq/g) of the latter, it is possible to write:

$${r}_{3} = \frac{{t}_{c c} ( PP 2 ) \times m ( PP 2 )}{{Σ}_{k} [ {m}_{k} ( amino compound ) \times {PA}_{k} ( amino compound ) ]}$$

where:
t_{cc} is the calculated content of functional groups T in the polyurethane (PP2) (meq/g) as defined above,
m (PP2) corresponds to the mass of polyurethane (PP2) as defined above,
PAₖ is the primary alkalinity of each amino compound,
Σₖ[mₖ (amino compound)×PAₖ (amino compound)] corresponds, for k=1, to the product of the mass of the amino compound used and of the primary alkalinity of said amino compound and, for k>1, to the sum of the products of the mass of each amino compound used and of their respective primary alkalinity,
k is an integer greater than or equal to 1.

The component (A) is heated, in a polypropylene reactor placed under a nitrogen atmosphere, to between 65 and 80° C. and then the component (B), consisting of the amino compound(s) (B1) and optionally of filler, is added with stirring. The mixture is produced under hot conditions at the temperature T3 of between 65 and 80° C. and is kept continually stirred for 2 minutes under vacuum (for debubbling).

The mixture is then left stirring until complete disappearance of the functional groups T visible in the infrared (signal at 1800 cm⁻¹).

Measurement of the Mechanical Performance Qualities: Breaking Strength and Elongation at Break of the Compositions According to the Invention in the Crosslinked State

Once crosslinked, the breaking strength and the elongation at break are measured by a tensile test on the adhesive composition according to the protocol described below.

The principle of the measurement consists in drawing, in a tensile testing device, the movable jaw of which is displaced at a constant rate equal to 100 mm/minute, a standard test specimen consisting of the crosslinked adhesive composition and in recording, at the moment when the test specimen breaks, the applied tensile stress (in MPa) and also the elongation of the test specimen (as %).

The standard test specimen is dumbbell-shaped, as illustrated in the international standard ISO 37. The narrow part of the dumbbell used has a length of 20 mm, a width of 4 mm and a thickness of 500 μm.

In order to prepare the dumbbell, the conditioned composition as described above is heated to 95° C. and then the amount necessary to form, on an A4 sheet of silicone-treated paper, a film having a thickness of 500 μm is extruded over this sheet, which film is left at 23° C. and 50% relative humidity for 7 days for crosslinking. The dumbbell is then obtained by simple cutting from the crosslinked film using a hollow punch.

The tensile strength test is repeated twice and gives the same results. The applied tensile stress recorded is expressed in megapascals (MPa, i.e. 10⁶ Pa) and the elongation at break is expressed as % with respect to the initial length of the test specimen. The values are combined in table 4 below.

TABLE 4

| | 1′ | 2′ | 3′ | 4′ |
|---|---|---|---|---|
| Applied tensile stress (MPa) | 4.7 | 2.2 | 3.2 | 1.5 |
| Elongation at break (%) | 110 | 530 | 320 | 660 |

Adhesiveness: Measurement of the Force of Shearing Under Stress (Lap Shear)

The adhesive compositions 1′, 3′ and 4′ according to the invention were furthermore subjected to tests of adhesive bonding of two small plates made of powdered aluminum (each with a size of 100 mm×25 mm) cleaned beforehand with a solvent (isopropanol). The adhesive composition is applied to one of the surfaces of the small plates using a spatula, within a space delimited by a Teflon window of 12.5 mm×25 mm. The other small plate is affixed over the adhesive-coated surface by pressing the two small plates against each other. After crosslinking at 23° C. and 50% relative humidity for seven days, the shear force at failure and also the failure facies are measured.

TABLE 5

| | 1′ | 3′ | 4′ |
|---|---|---|---|
| Shear force at failure (MPa) | 7.2 | 4.1 | 3.3 |
| Type of failure | CF | CF | CF |

“CF” denotes cohesive failure, meaning that it is observed that a part of the adhesive joint is adhesively bonded to both faces of the laminated small plates.

Thus, the adhesive compositions according to the invention can be easily formulated using a preparation process which is relatively inexpensive in energy, which is friendly to man and to his environment and which does not employ solvent or plasticizer.

In addition, the adhesive compositions according to the invention thus obtained result in adhesives which are effective in terms of mechanical properties and/or of adhesive force and which are suitable for a broad panel of applications.

1-16. (canceled)

17. A polyurethane (PP2) comprising at least two end functional groups T of following formula (I): 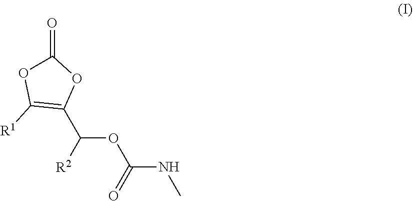
wherein R¹ and R², which are identical or different, each represent a hydrogen atom, a linear or branched alkyl group, a cycloalkyl group, a phenyl group, or an alkylphenyl group with a linear or branched alkyl chain; or R¹ and R² can be bonded together to form a —(CH₂)ₙ— group with n=3, 4 or 5.

18. The polyurethane as claimed in claim 17, additionally comprising at least one repeat unit comprising one of the following divalent radicals R³:
a) —(CH₂)₅— divalent radical derived from pentamethylene diisocyanate (PDI),
b) —(CH₂)₆— divalent radical derived from hexamethylene diisocyanate (HDI),
c) the divalent radical derived from isophorone: 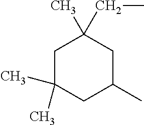
d) the divalent radical derived from 2,4-TDI: 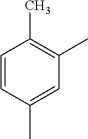
e) the divalent radical derived from 2,4′-MDI: 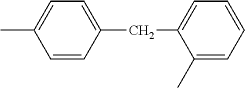
f) the divalent radical derived from meta-xylylene diisocyanate (m-XDI): 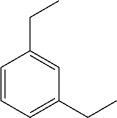
g) the divalent radical derived from 1,3-bis(isocyanatomethyl)cyclohexane (m-H6XDI): 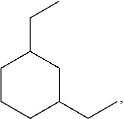
or
h) the divalent radical derived from 4,4′-methylenedicyclohexyl diisocyanate (H12MDI):

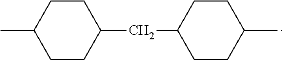

19. The polyurethane as claimed in claim 18, having the following formula (III): 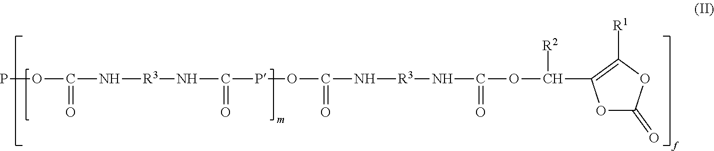
wherein:
R¹ and R², which are identical or different, each represent a hydrogen atom, a linear or branched alkyl group, a cycloalkyl group, a phenyl group, or an alkylphenyl group with a linear or branched alkyl chain; or R¹ and R² can be bonded together to form a —(CH₂)ₙ— group with n=3, 4 or 5;
P represents one of the two formulae below: 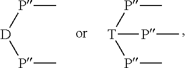
wherein D and T represent, independently of each other, a hydrocarbon radical comprising from 2 to 66 carbon atoms which is linear or branched, cyclic, alicyclic or aromatic, saturated or unsaturated, optionally comprising one or more heteroatoms;
P′ and P″ being, independently of each other, a divalent radical resulting from a polyol;
R³ being as defined in claim 18;
R represents a linear or branched divalent alkylene radical comprising from 2 to 4 carbon atoms;
m and f are integers such that the average molecular mass of the polyurethane ranges from 600 to 100 000 g/mol; and
f is equal to 2 or 3.

20. The polyurethane as claimed in claim 17, wherein it is obtained by reaction of a polyurethane having NCO end groups and of at least one compound of following formula (III): 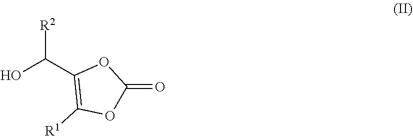
in which R¹ and R² are as defined in claim 17.

21. A process for the preparation of a polyurethane (PP2) as claimed in claim 17, comprising:
in a first stage (denoted E1), the preparation of a polyurethane having NCO end groups (PP1) by a polyaddition reaction:
i. of at least one polyisocyanate selected from the group consisting of the following:
a1) pentamethylene diisocyanate (PDI),
a2) hexamethylene diisocyanate (HDI),
a3) isophorone diisocyanate (IPDI),
a4) 2,4-toluene diisocyanate (2,4-TDI),
a5) 2,4′-diphenylmethane diisocyanate (2,4′-MDI),
a6) meta-xylylene diisocyanate (m-XDI),
a7) 1,3-bis(isocyanatomethyl)cyclohexane (m-H6XDI),
a8) 4,4′-methylenedicyclohexyl diisocyanate (H12MDI),
a9) and their mixtures;
ii. with at least one polyol, in amounts of polyisocyanate(s) and of polyol(s) resulting in an NCO/OH molar ratio, denoted r₁, strictly of greater than 1; and
in a second stage (denoted E2), the reaction of the product formed on conclusion of the first stage E1 with at least one compound of formula (III): 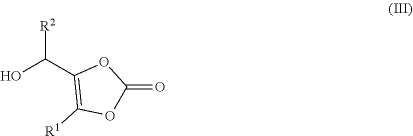
wherein R¹ and R² are as defined in claim 17, in amounts such that the NCO/OH molar ratio, denoted r₂, is less than or equal to 1.

22. The preparation process as claimed in claim 21, wherein it does not comprise a stage consisting in adding one or more solvent(s) and/or plasticizer(s).

23. The preparation process as claimed in claim 21, wherein the polyol is selected from the group consisting of:
polyether polyols chosen from polyoxyalkylene polyols, the linear or branched alkylene part of which comprises from 1 to 4 carbon atoms,
polybutadienes comprising hydroxyl end groups, which are optionally hydrogenated or epoxidized, and
their mixtures.

24. The preparation process as claimed in claim 21, wherein the polyol(s) is (are) chosen from those having a number-average molecular mass ranging from 200 to 20,000 g/mol.

25. The preparation process as claimed in claim 21, wherein the diisocyanate is 2,4-toluene diisocyanate.

26. A multicomponent system, comprising:
as first component (component A), a composition comprising at least one polyurethane (PP2) as defined in claim 17, and
as second component (component B), a composition comprising at least one amino compound (B1) comprising at least two amine groups chosen from primary amine groups, secondary amine groups and their mixtures.

27. The multicomponent system as claimed in claim 26, wherein said amino compound(s) (B1) has (have) a primary alkalinity ranging from 0.4 to 34 meq/g of amino compound.

28. The multicomponent system as claimed in claim 26, wherein the amino compound(s) (B1) comprise at least two methyleneamine (—CH₂—NH₂) groups.

29. The multicomponent system as claimed in claim 26, wherein the amounts of polyurethane(s) (PP2) and of amino compound(s) (B1) present in the multicomponent system result in a molar ratio of the number of functional groups T of formula (I) to the number of primary and/or secondary amine groups, denoted r₃, ranging from 0.5 to 1.

30. The multicomponent system as claimed in claim 26, wherein it comprises at least one inorganic filler.

31. A process for assembling materials employing the polyurethane (PP2) as defined in claim 17, comprising the following stages:
mixing at least one polyurethane (PP2) as defined in claim 17 and at least one amino compound (B1) comprising at least two amine groups chosen from primary amine groups, secondary amine groups and their mixtures to form a first mixture;
coating said first mixture onto a surface of a first material to form a coated surface, then
laminating a surface of a second material onto said coated surface, then
crosslinking said first mixture.
